(19) United States
(12) Patent Application Publication
(10) Pub. No.: US 2018/0149272 A1
(43) Pub. Date: May 31, 2018

(54) CONCAVE-PLATE TRIPLE ECCENTRIC BUTTERFLY VALVE

(71) Applicants: SHUGUANG CHEN, SHANGHAI (CN); XINYANG LIU, SHANGHAI (CN)

(72) Inventors: SHUGUANG CHEN, SHANGHAI (CN); XINYANG LIU, SHANGHAI (CN)

(21) Appl. No.: 15/588,484

(22) Filed: May 5, 2017

(30) Foreign Application Priority Data
Nov. 29, 2016 (CN) 201611072419.3

(51) Int. Cl. F16K 1/22; F16K 1/226

(52) U.S. Cl. CPC F16K 1/222; F16K 1/2263

(57) ABSTRACT

Provided is a concave-plate triple eccentric butterfly valve, which includes a valve body, a upper valve stem, a valve seat, a valve plate, and a lower valve stem, among which the valve plate has a concave structure. When used in an isolation function application as well as in a fully open state, the valve plate is hidden behind the valve seat and the fluid passage of the valve is a smooth fluid passage, the valve can have a greater flow capacity. The flow of the fluid does not flush the valve plate sealing surface from the front. During the opening and closing process, the turbulence caused by the disturbance of the fluid is reduced and therefore the vibration of the system is reduced. In adjustment applications, the adjusting sleeve concave spherical surface, the adjusting sleeve fluid passage, and the valve plate convex spherical surface can cooperate to form the fluid passage adjusting opening.

### CROSS REFERENCE TO RELATED APPLICATIONS

This application claims the benefit of and priority to Application No. 201611072419.3, field on Nov. 29, 2016, in the Patent Office of the People's Republic of China, which disclosure is herein incorporated by reference.

### BACKGROUND

The present disclosure relates to relates to a butterfly valve, and particularly to a concave-plate triple eccentric butterfly valve.

Butterfly valve, also known as flap valve, is an isolation shut-off valve with a simple structure and can be used for opening-closing control of low-pressure pipe media; the valve has a closing component (a valve plate or butterfly plate), which is a flat disc and configured to rotate around a valve stem to enable opening and closing. Valves can be used to control the flow of various types of fluids such as air, water, steam, all kinds of corrosive media, mud, oil, liquid metal, and radioactive media.

Triple eccentric (tri-eccentric) butterfly valve is a commonly used butterfly valve, and existing butterfly valve manufacturing companies include ADAMS from Germany, VANESSA from Italy, BRAY from the United States, VENAN from Canada and so on. The shortcomings of the butterfly valves produced by these companies are as follows. When the valve is in an open state, the valve plate is always in the middle of the fluid passage and the fluid, which is caused by the inherent flat plate structure of the butterfly valve; when passing through a passage of a valve body, the fluid is divided into two parts by the valve plate. The valve plate in the middle of the fluid can produce a large flow resistance on the fluid, which greatly reduces the flow capacity of the valve; at the same time, the two parts of fluid bypassing the valve plate will converge and collide again and form turbulence, this can cause vibration to a piping system; besides, a valve seat is continually flushed by the fluid media from the front. Moreover, during a valve opening-closing process, the valve plate has a very large disturbance on the fluid, and great turbulence can be formed. Therefore, in the process of pipeline design with regard to valve selection, the use of butterfly valves is restricted because the flow capacity thereof is relatively small; in addition, when used in adjustment applications, it is impossible for the butterfly valves to obtain accurate adjustment characteristics required due to the fixed plate design of the valve plate, and this can also limits the use of the butterfly valves.

### BRIEF DESCRIPTION OF THE INVENTION

The present disclosure aims to provide a concave-plate triple eccentric butterfly valve, so as to solve the problems set forth in the background.

In order to achieve the above object, the following technical solutions are provided.

A concave-plate triple eccentric butterfly valve, includes a valve body, a upper valve stem, a valve seat, a valve plate, and a lower valve stem; the valve plate has a concave structure; both the upper valve stem and the lower valve stem penetrate into the valve body from the diameter direction of the valve body and are coupled with the valve plate; the valve seat is fixed in the inner cavity of the valve body and provided with a valve seat sealing surface; the valve plate is fixed on the upper valve stem and the lower valve stem; the valve seat sealing surface and a sealing surface of the valve plate coincide; and a sealing structure between the valve plate and the valve seat has a triple eccentric structure.

As a further implementation, the valve body is provided with a fluid passage and the fluid passage is internally fixed with an adjusting sleeve; the valve plate is provided with a valve plate convex spherical surface and a valve plate concave; the adjusting sleeve is provided with an adjusting sleeve concave spherical surface and an adjusting sleeve fluid passage, and the adjusting sleeve fluid passage penetrates the adjusting sleeve concave spherical surface; the adjusting sleeve concave spherical surface and the valve plate convex spherical surface form spherical matching, and the valve plate convex spherical surface and the adjusting sleeve concave spherical surface can cooperate to form a fluid passage adjusting opening.

Compared with the related art, the present disclosure has the following advantageous effects. The product of the present disclosure has a reasonable design and low failure rate, and has good running stability either. When used in an isolation function application as well as in a fully open state, the valve plate is hidden behind the valve seat and the fluid passage of the valve is a smooth fluid passage (in other words, flow passage), therefore, the valve can have a greater flow capacity; besides, the flow of the fluid does not flush the valve plate sealing surface from the front. In addition, during the opening and closing process, the turbulence caused by the disturbance of the fluid is reduced and therefore the vibration of the system is reduced. In an adjustment function application, the adjusting sleeve concave spherical surface, the adjusting sleeve fluid passage, and the valve plate convex spherical surface can cooperate to form the fluid passage adjusting opening; therefore, it is possible to obtain adjustment characteristics set as required. As a result of the fluid adjustment acting directly on a straight fluid passage, the valve has a greater adjustment ratio and can provide better use effects.

### BRIEF DESCRIPTION OF THE DRAWINGS

FIG. 1 is a sectional view illustrating a closed state of isolation function of a concave-plate triple eccentric butterfly valve.

FIG. 2 is a schematic diagram illustrating a triple eccentric structure of the concave-plate triple eccentric butterfly valve.

FIG. 3 is a sectional view illustrating an open state of the isolation function of the concave-plate triple eccentric butterfly valve.

FIG. 4 is a left view illustrating the open state of the isolation function of the concave-plate triple eccentric butterfly valve.

FIG. 5 is a front view illustrating a valve plate in an isolation function state of the concave-plate triple eccentric butterfly valve.

FIG. 6 is a top view illustrating the valve plate in the isolation function state of the concave-plate triple eccentric butterfly valve.

FIG. 7 is a right view illustrating the valve plate in the isolation function state of the concave-plate triple eccentric butterfly valve.

FIG. 8 is a sectional view illustrating adjustment function of the concave-plate triple eccentric butterfly valve.

FIG. 9 is a right view illustrating the adjustment function of the concave-plate triple eccentric butterfly valve.

FIG. 10 is a front view illustrating the valve plate in an adjustment function state of the concave-plate triple eccentric butterfly valve.

FIG. 11 is a top view illustrating the valve plate in the adjustment function state of the concave-plate triple eccentric butterfly valve.

FIG. 12 is a right view illustrating the valve plate in the adjustment function state of the concave-plate triple eccentric butterfly valve.

FIG. 13 is a front view illustrating an adjusting sleeve with adjustment function of the concave-plate triple eccentric butterfly valve.

FIG. 14 is a right view illustrating the adjusting sleeve with adjustment function of the concave-plate triple eccentric butterfly valve.

Among which, the reference numerals are as follows: 1—valve body, 2—upper valve stem, 3—valve plate, 4—valve seat, 5—adjusting sleeve, 6—lower valve stem, 7—valve seat sealing surface, 8—valve plate concave surface, 9—fluid passage, 10—valve plate convex spherical surface, 11—adjusting sleeve concave spherical surface, 12—adjusting sleeve fluid passage, 13—fluid passage adjusting opening.

### DETAILED DESCRIPTION OF ILLUSTRATED EMBODIMENTS

The technical solution of the present disclosure will be described in further detail with reference to embodiments.

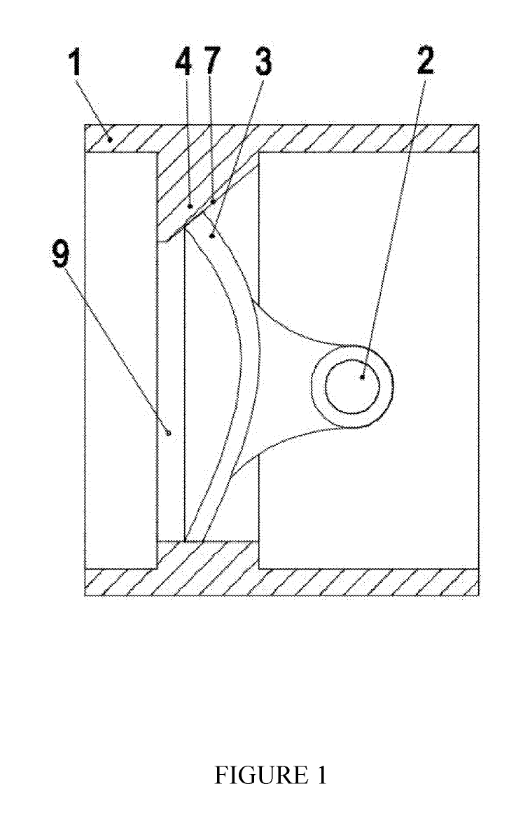

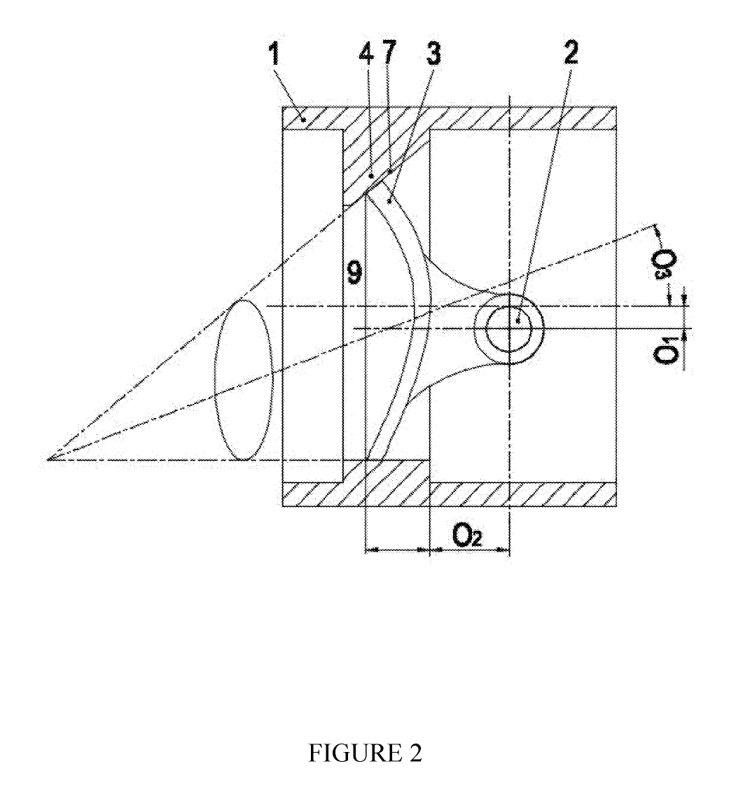

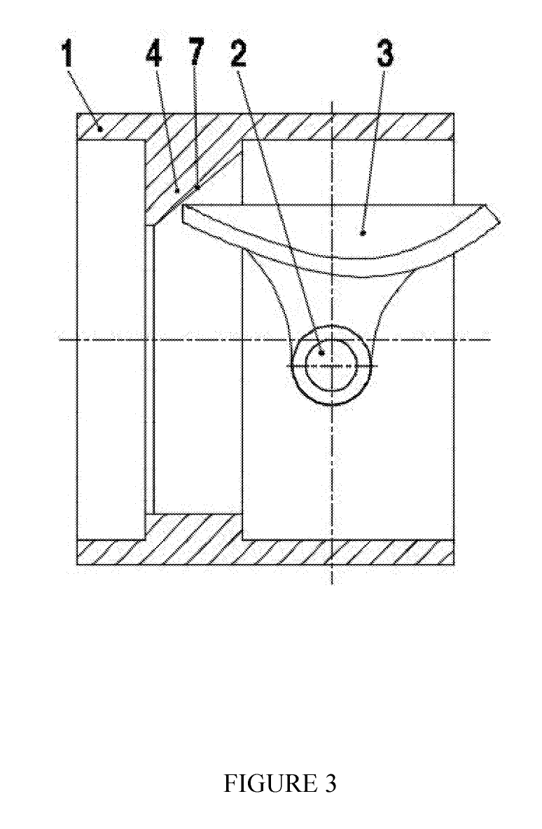

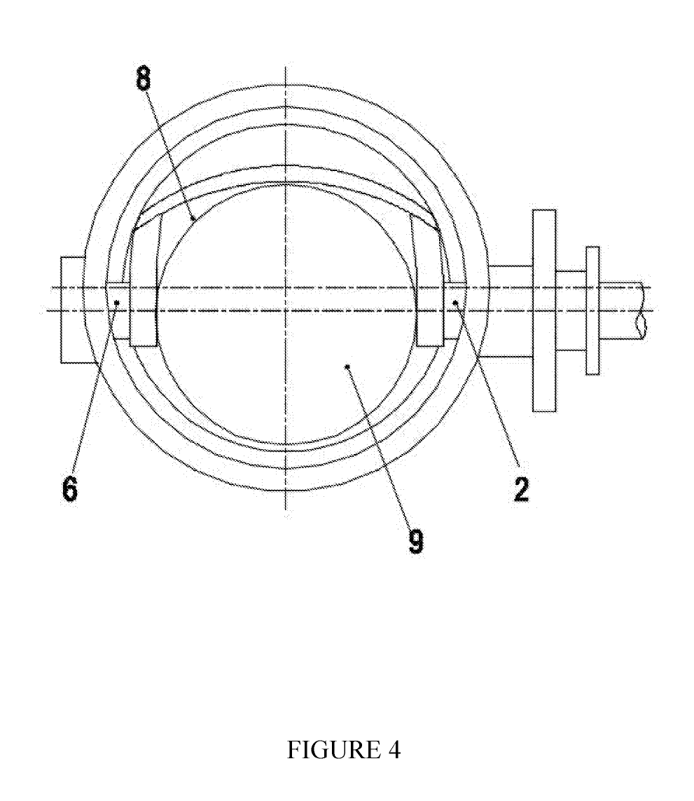

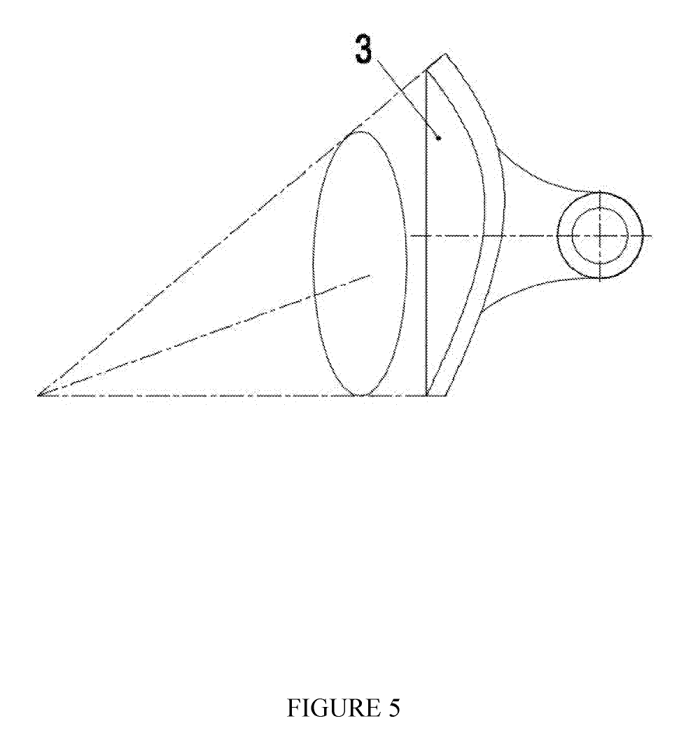

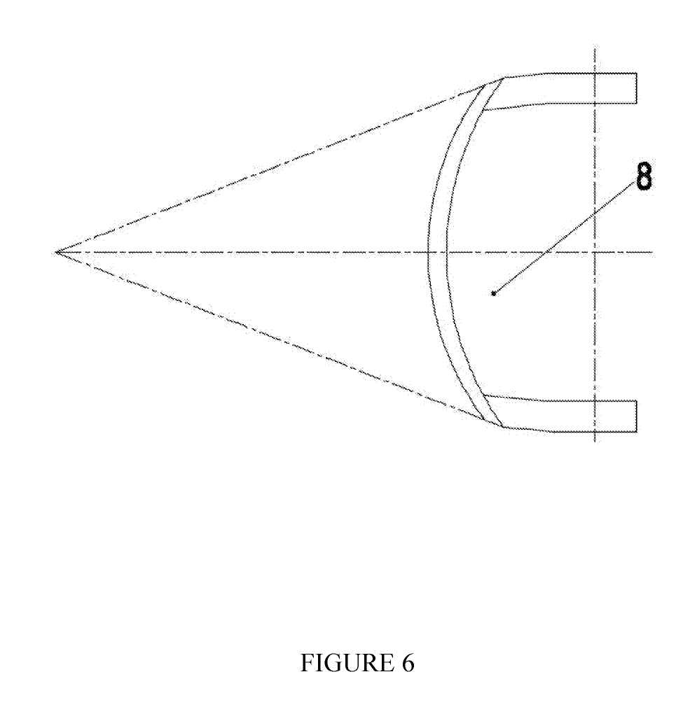

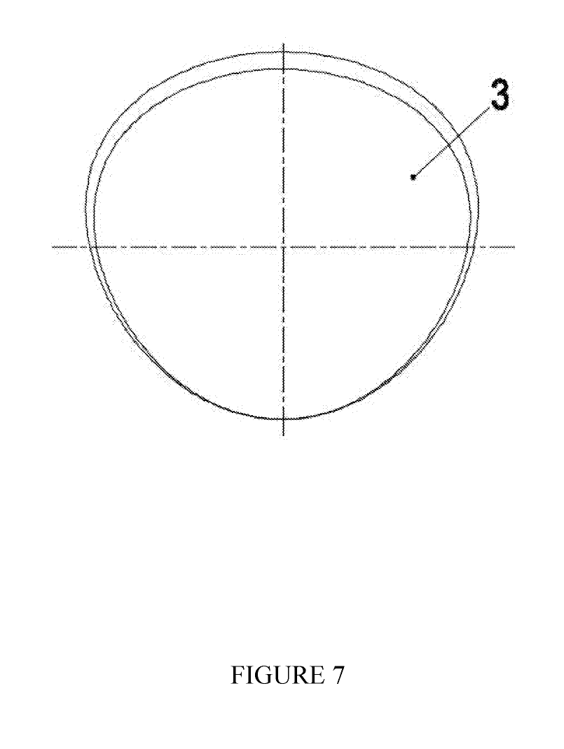

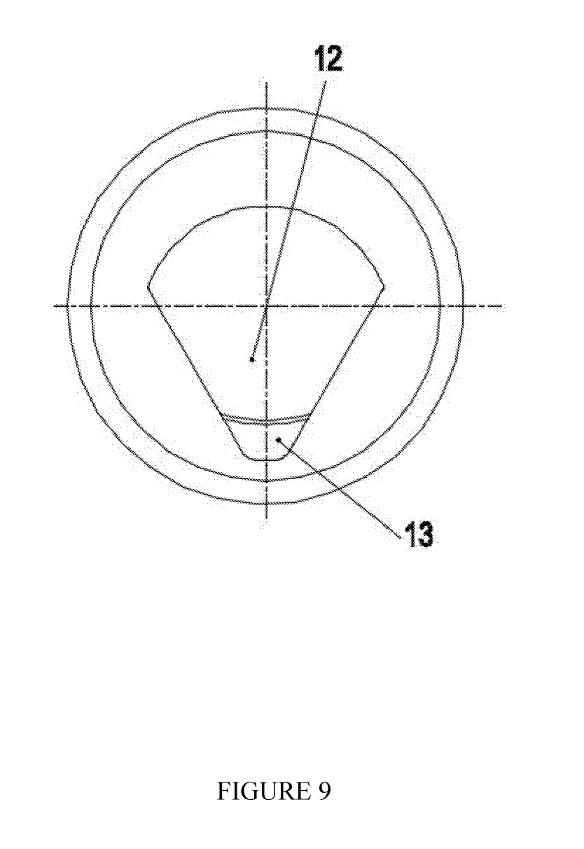

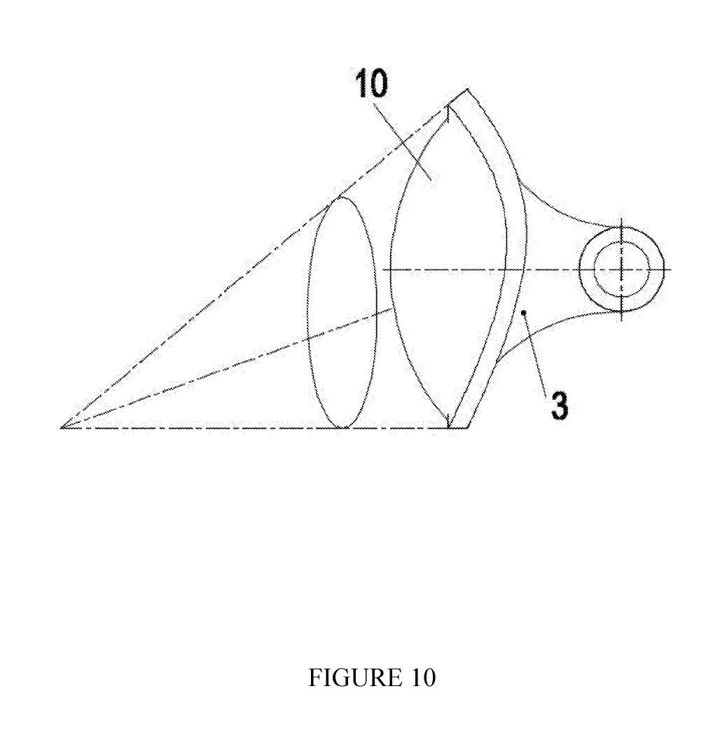

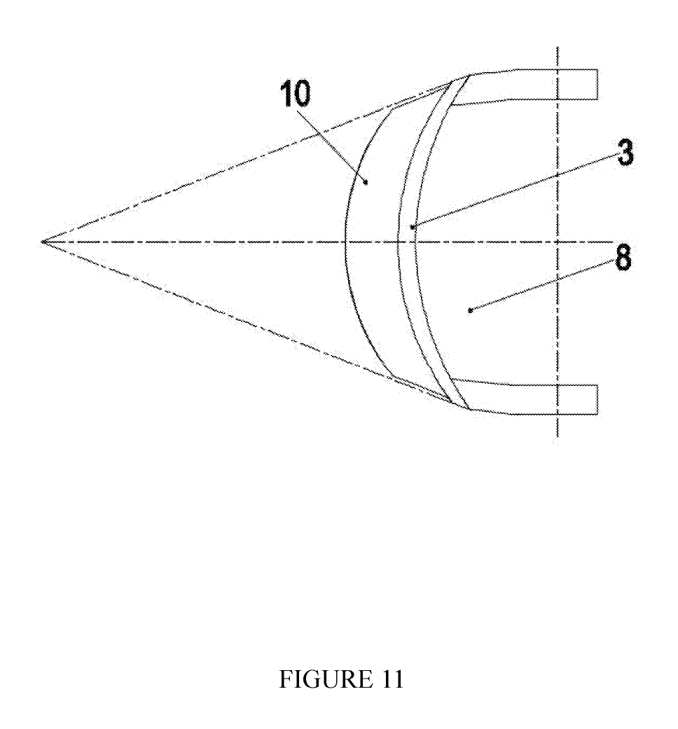

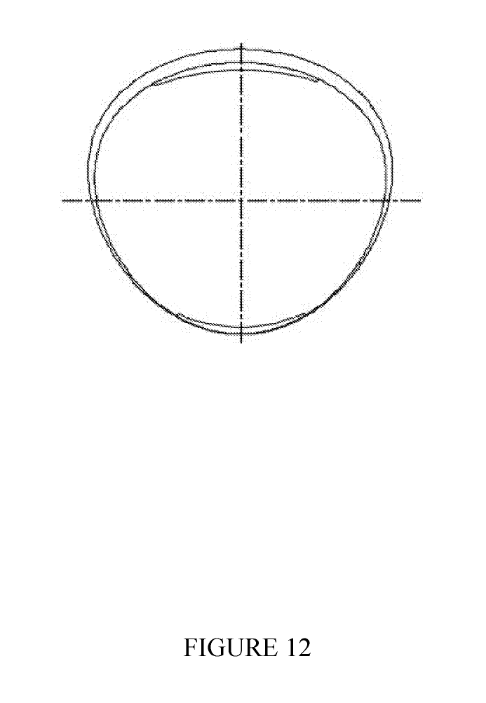

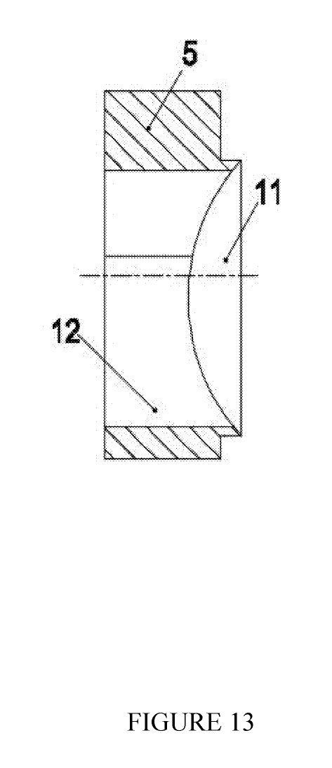

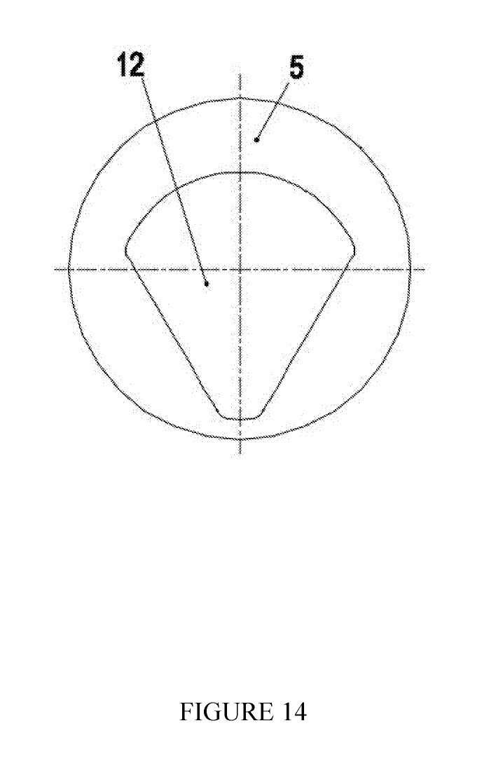

Refer to FIG. 1-FIG. 14, a concave-plate triple eccentric butterfly valve is provided, and in an isolation function application, the concave-plate triple eccentric butterfly valve can include a valve body 1, an upper valve stem 2, a valve plate 3, a valve seat 4, and a lower valve stem 6. The valve plate 3 uses a concave structure; both the upper valve stem 2 and the lower valve stem 6 penetrate into the valve body 1 from the diameter direction of the valve body 1 and are coupled with the valve plate 3. The valve plate 3 is fixed on the upper valve stem 2 and the lower valve stem 6. The valve seat 4 is fixed in the inner cavity of the valve body 1, and a valve seat sealing surface 7 is provided on the valve seat 4. When the valve is closed, a sealing surface of the valve plate 3 and the valve seat sealing surface 7 coincide, and a sealing structure between the valve plate 3 and the valve seat 4 uses a triple eccentric structure. The triple eccentric structure includes a first eccentric structure O₁, a second eccentric structure O₂, and a third eccentric structure O₃, among which the first eccentric structure O₁ is that the centerline of the upper valve stem 2 and the lower valve stem 6 is eccentric to the centerline of the valve body 1, the second eccentric structure O₂ is that the centerline of the upper valve stem 2 and the lower valve stem 6 is eccentric to the centerline of the valve seat sealing surface 7, and the third eccentric structure O₃ is that the oblique taper centerline of the valve seat sealing surface 7 is eccentric to the centerline of a pipeline.

In an adjustment function application, on the basis of the isolation function, a fluid passage 9 of the valve body 1 is further fixed with an adjusting sleeve 5. The adjusting sleeve 5 is provided with an adjusting sleeve concave spherical surface 11 and an adjusting sleeve fluid passage 12, and the adjusting sleeve fluid passage 12 penetrates the adjusting sleeve concave spherical surface 11. The valve plate 3 is provided with a valve plate concave surface 8 and a valve plate convex spherical surface 10, and the valve plate convex spherical surface 10 and the adjusting sleeve concave spherical surface 11 are spherical matched. The valve plate convex spherical surface 10, the adjusting sleeve concave spherical surface 11, and the adjusting sleeve fluid passage 12 cooperate to form a fluid passage adjusting opening 13.

The working principle of the present disclosure is as follows.

In the isolation function, as illustrated in FIG. 1-FIG. 7, the valve plate 3 is a valve plate with a concave structure, both the upper valve stem 2 and the lower valve stem 6 penetrate into the valve body 1 from the diameter direction of the valve body 1 and are mechanically coupled with the valve plate 3; the valve seat 4 is fixed in the inner cavity of the valve body 1. When the valve is in an open state, due to the concave structure of the valve plate 3, the valve plate 3 is located behind the valve seat sealing surface 7 relative to the fluid flow direction, and the valve plate concave surface 8 and the passage of the valve body combined into a fluid passage 9 for smooth flow of convergence. During the opening process of the valve, that is, the process that the valve plate 3 rotates gradually to hide behind the valve seat sealing surface 7, in other words, the process that the fluid passage 9 is progressively formed, there is no large turbulence formed due to multi-directional fluid collisions.

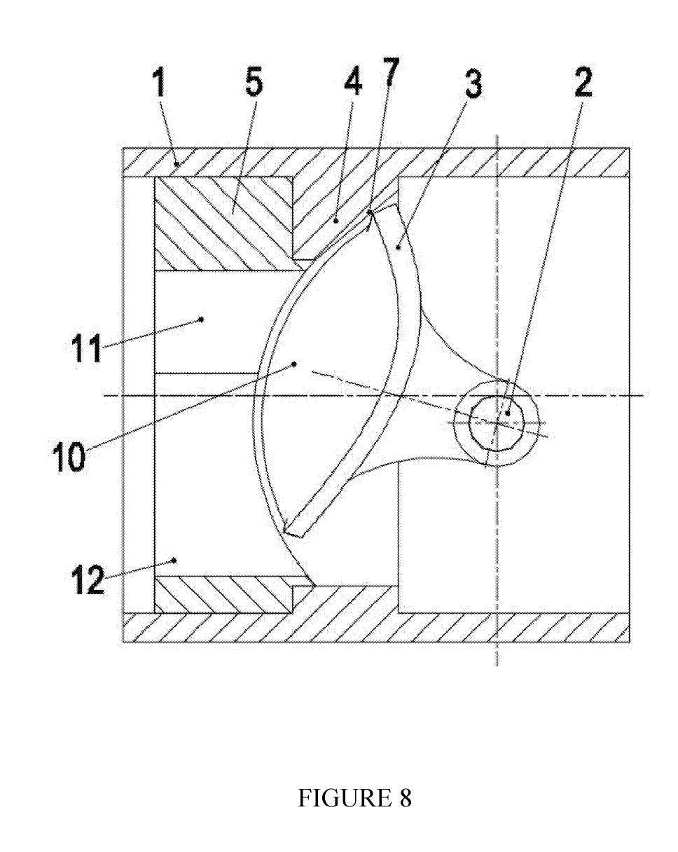

In the adjustment function, as illustrated in FIG. 8-FIG. 14, driven by the rotation of the upper valve stem 2, the valve plate 3 including the valve plate convex spherical surface 10 also rotates accordingly. Relative to the adjusting sleeve concave spherical surface 11 cooperating with the fluid passage adjusting opening 13 and the adjusting sleeve fluid passage 12, a gradually changed fluid passage adjusting opening 13 is formed through the rotation of the valve plate convex spherical surface 10. The opening size of the fluid passage adjusting opening 13 determines the flow capacity of the fluid, and the flow capacity formed by gradually opening the fluid passage adjusting opening 13 and the rotation angle of the upper valve stem 2 directly correspond to accurate adjustment characteristics. The shape of the adjusting sleeve fluid passage 12 of the adjusting sleeve 5 directly determines the required fluid characteristics. In addition, relative to the pipeline direction of the valve, the fluid passage 9 formed by the inner cavity of the valve body 1 and the valve plate concave surface 8 of the valve plate 3 is a straight-through fluid passage. The fluid passage 9 can be infinitely close to the inner cavity of the valve body 1; the adjusting sleeve 5 is directly in the inner cavity in the pipeline direction of the valve body 1, and the adjusting sleeve fluid passage 12 of the adjusting sleeve 5 can be infinitely close to the fluid passage 9; therefore, in the fully opened state, in accordance with the flow capacity set by the adjusting sleeve fluid passage 12 of the adjusting sleeve 5, the flow capacity of the valve can be made close to the flow capacity of the valve body 1, and therefore, the adjustment ratio is relatively large. During the valve adjustment process, the rotation of the valve plate 3 can directly adjust the fluid flowing through the fluid passage 9.

The product of the present disclosure has a reasonable design and low failure rate, and has good running stability either. When used in the isolation function application and in the fully open state, the valve plate 3 is hidden behind the valve seat 4 and the fluid passage 9 of the valve is a smooth fluid passage, therefore, the valve can have a greater flow capacity; besides, the flow of the fluid does not flush the valve plate sealing surface from the front. In addition, during the opening and closing process, the turbulence caused by the disturbance of the fluid is reduced and therefore the vibration of the system is reduced accordingly, and better user effects can be achieved. When used in the adjustment function application, the adjusting sleeve fluid passage 12 of the adjusting sleeve 5 can be set to be a fluid passage with the required accurate adjustment characteristics, and the adjustment amount of the fluid passage can be close to the flow capacity of the valve body, therefore, a greater adjustment ratio can be provided.

While the present disclosure has been described in detail above with reference to the exemplary embodiments, the scope of the present disclosure is not limited thereto. As will occur to those skilled in the art, the present disclosure is susceptible to various modifications and changes without departing from the spirit and principle of the present disclosure. Therefore, the scope of the present disclosure should be determined by the scope of the claims. Any reference signs in the claims should not be construed as limiting the claims to which they relate.

In addition, it should be understood that, although this description is described in terms of embodiments, not each embodiment includes only one independent solution and the manner of description is merely for clarity. Those skilled in the art should refer to the specification as a whole; the technical solutions of the embodiments may be combined as appropriate to form other embodiments that may be understood by those skilled in the art.

We claim:

1. A concave-plate triple eccentric butterfly valve, comprising a valve body, a upper valve stem, a valve seat, a valve plate, and a lower valve stem, wherein the valve plate has a concave structure, both the upper valve stem and the lower valve stem penetrate into the valve body from the diameter direction of the valve body and are coupled with the valve plate; the valve seat is fixed in the inner cavity of the valve body and a valve seat sealing surface is provided on the valve seat; the valve plate is fixed on the upper valve stem and the lower valve stem; the valve seat sealing surface and a valve plate sealing surface coincide; and a sealing structure between the valve plate and the valve seat has a triple eccentric structure.

2. The concave-plate triple eccentric butterfly valve of claim 1, wherein the valve body is provided with a fluid passage and the fluid passage is internally fixed with an adjusting sleeve; the valve plate is provided with a valve plate convex spherical surface and a valve plate concave; the adjusting sleeve is provided with an adjusting sleeve concave spherical surface and an adjusting sleeve fluid passage, the adjusting sleeve fluid passage penetrates the adjusting sleeve concave spherical surface; the adjusting sleeve concave spherical surface and the valve plate convex spherical surface form spherical matching, and the valve plate convex spherical surface and the adjusting sleeve concave spherical surface cooperate to form a fluid passage adjusting opening.
